(19) United States
(12) Patent Application Publication
(10) Pub. No.: US 2024/0241981 A1
(43) Pub. Date: Jul. 18, 2024

(54) METHODS AND SYSTEMS FOR DATA SYNCHRONIZATION, AND COMPUTER-READABLE STORAGE MEDIA

(71) Applicant: BOE Technology Group Co., Ltd., Beijing (CN)

(72) Inventor: Liwei TONG, Beijing (CN)

(21) Appl. No.: 18/559,010

(22) PCT Filed: Feb. 20, 2023
(86) PCT No.: PCT/CN2023/077058

§ 371 Date: Nov. 3, 2023

(30) Foreign Application Priority Data
Mar. 28, 2022 (CN) 202210316593.7

(51) Int. Cl. G06F 21/62; G06F 21/32; H04L 9/32

(52) U.S. Cl. CPC G06F 21/6218; G06F 21/32; H04L 9/3242

(57) ABSTRACT

The present disclosure relates to a method and a system for data synchronization, and a computer-readable storage medium. The method includes: obtaining initial source data from a source database; generating fingerprint data for the initial source data to obtain target source data containing the fingerprint data, where the fingerprint data serves as a primary key of the initial source data; and synchronizing the target source data to a target database, to enable the target source data to be stored in the target database after a verification for the primary key is passed. In this embodiment, generating fingerprint data with a unique feature for the initial source data can solve the problem of repeated synchronization during the data synchronization process, which improves the accuracy and efficiency of data synchronization.

### TECHNICAL FIELD

The present disclosure relates to the technical field of data processing, in particular to methods and systems for data synchronization, and computer-readable storage media.

### BACKGROUND

An existing offline synchronization tool for heterogeneous data sources are committed to achieving stable and efficient data synchronization functions between various heterogeneous data sources including relational databases (MySQL, Oracle, etc.), HDFS, Hive, ODPS, HBase, FTP, etc. The offline synchronization tool for heterogeneous data sources serves as an offline data synchronization framework, which is constructed by using the Framework+plugin architecture, abstracting reading and writing of a data source into Reader/Writer plugins which are integrated into the entire synchronization framework.

Considering that the data to be synchronized comes from different data sources, and data from different data sources may use different types of primary keys (such as string-type uuids, database-auto-increment numeric primary keys, or custom-rule primary keys). In practical applications, some source data read by the Reader plugin do not have a primary key. In this case, it is necessary to use a relational database to generate an auto-increment primary key, which may cause duplicate data insertion during incremental-data synchronization. In addition, since the Reader plugin and the Writer plugin may be located on different nodes, and the existing offline synchronization tool for heterogeneous data sources does not have a secure processing mechanism, it is impossible to detect data that has been tampered with during data synchronization transmission.

### SUMMARY

The present disclosure provides methods and systems for data synchronization, and computer-readable storage media, to address the shortcomings of related technologies.

According to the first aspect of the embodiments of the present disclosure, a method for data synchronization is provided, which is applied to a system for data synchronization, and includes:
obtaining initial source data from a source database;
generating fingerprint data for the initial source data to obtain target source data containing the fingerprint data, where the fingerprint data serves as a primary key of the initial source data; and
synchronizing the target source data to a target database, to enable the target source data to be stored in the target database after a verification for the primary key is passed.

In some embodiments, generating the fingerprint data for the initial source data includes:
calling a preset fingerprint generating model; and
inputting the initial source data to the fingerprint generating model, to obtain the fingerprint data.

In some embodiments, the preset fingerprint generating model can be implemented by using at least one of a message digest algorithm, a secure hash algorithm, a message authentication code algorithm, or a key-based message authentication code algorithm.

In some embodiments, synchronizing the target source data to the target database includes:
generating verification fingerprint data based on the initial source data in the target source data; and
in response to determining that the primary key in the target source data is the same as the verification fingerprint data, transmitting the target source data to the target database.

In some embodiments, the method further includes:
obtaining, by the target database, the primary key in the target source data and determining whether there is a primary key of stored data that is matched with the primary key in the target source data;
in response to determining that the primary key of the target source data exists in the target database, updating the target source data to the target database;
in response to determining that the primary key of the target source data does not exist in the target database, inserting the target source data into the target database.

In some embodiments, synchronizing the target source data to the target database includes:
obtaining first fingerprint data of data columns other than a newly added data column and second fingerprint data of data columns containing the newly added data column; and
determining whether there is a primary key in the target database that is matched with the first fingerprint data;
in response to determining that the primary key of the target source data exists in the target database, updating the target source data and the second fingerprint data to the target database.

In some embodiments, the method further includes:
obtaining history task information;
determining column combinations in the target source data used in the history task information; and
generating fingerprint data based on column data of the column combinations, and synchronously storing the fingerprint data as a secondary key of the target source data in the target database.

According to the second aspect of the embodiments of the present disclosure, a system for data synchronization is provided, which includes a source database, a target database, and a data synchronization apparatus; where
the data synchronization apparatus is configured to obtain initial source data from the source database and generate fingerprint data for the initial source data, to obtain target source data containing the fingerprint data, where the fingerprint data serves as a primary key of the initial source data; and synchronize the target source data to the target database to store the target source data after a verification for the primary key is passed.

In some embodiments, the data synchronization apparatus includes a Framework module, a fingerprint data generating module, a read plugin, and a write plugin, where the Framework module is separately connected to the read plugin and the write plugin, where
the read plugin is configured to read the initial source data to be synchronized from the source database;
the fingerprint data generating module is configured to generate fingerprint data for the initial source data and use the fingerprint data as the primary key of the initial source data;
the Framework module is configured to forward the initial source data and the primary key together as the target source data to the write plugin; and
the write plugin is configured to write the target source data to the target database.

In some embodiments, the fingerprint data generating module is integrated into the read plugin and/or the Framework module.

In some embodiments, the fingerprint data generating module is integrated into the write plugin for generating verification fingerprint data based on the initial source data in the target source data, and the write plugin is further configured to compare the primary key in the target source data with the verification fingerprint data, and transmit the target source data to the target database in response to determining that the primary key is the same as the verification fingerprint data.

In some embodiments, the write plugin in the data synchronization apparatus is further configured to: obtain first fingerprint data of data columns other than a newly added data column and second fingerprint data of data columns containing the newly added data column; and determine whether there is a primary key in the target database that is matched with the first fingerprint data; in response to determining that the primary key of the target source data exists in the target database, update the target source data and the second fingerprint data to the target database.

In some embodiments, the data synchronization apparatus is further configured to: obtain history task information; determine column combinations in the target source data used in the history task information; and generate fingerprint data based on column data of the column combinations, and synchronously store the fingerprint data as a secondary key of the target source data in the target database.

According to the third aspect of embodiments of the present disclosure, a non-transitory computer-readable storage medium is provided, where when an executable computer program in the storage medium is executed by a processor, the method according to the first aspect is implemented.

The technical solutions provided by the embodiments of the present disclosure can include following beneficial effects.

From the above embodiments, it can be seen that in the solution provided in embodiments of the present disclosure, initial source data can be obtained from the source database and fingerprint data can be generated for the initial source data, to obtain target source data containing the fingerprint data, where the fingerprint data serves as a primary key of the initial source data; and the target source data can be synchronized to the target database to store the target source data after a verification for the primary key is passed. In this embodiment, generating fingerprint data with a unique feature for the initial source data can solve the problem of repeated synchronization during the data synchronization process, which improves the accuracy and efficiency of data synchronization.

It is to be understood that the above general descriptions and the below detailed descriptions are merely exemplary and explanatory, and are not intended to limit the present disclosure.

### BRIEF DESCRIPTION OF DRAWINGS

Accompanying drawings herein are incorporated into and constitute a part of the specification, illustrate embodiments consistent with the present disclosure, and are combined with the description to explain the principle of the present disclosure.

FIG. 1 is a block diagram of a system for data synchronization according to an embodiment.

FIG. 2 is a block diagram of a system for data synchronization according to an embodiment.

FIG. 3 is a flowchart of a method for data synchronization according to an embodiment.

FIG. 4 is a schematic diagram of an application scenario of a system for data synchronization according to an embodiment.

FIGS. 5 to 8 are schematic diagrams of effects of configuring tasks according to some embodiments.

FIG. 9 is a flowchart of data synchronization according to an embodiment.

### DETAILED DESCRIPTION

Embodiments will be described in detail herein, examples of which are illustrated in the accompanying drawings. Where the following description refers to the drawings, elements with the same numerals in different drawings refer to the same or similar elements unless otherwise indicated. Embodiments described in the illustrative examples below are not intended to represent all embodiments consistent with the present disclosure. Rather, they are merely embodiments of devices consistent with some aspects of the present disclosure as recited in the appended claims. It should be noted that, without conflict, features in following embodiments can be combined with each other.

An existing offline synchronization tool for heterogeneous data sources are committed to achieving stable and efficient data synchronization functions between various heterogeneous data sources including relational databases (MySQL, Oracle, etc.), HDFS, Hive, ODPS, HBase, FTP, etc. The offline synchronization tool for heterogeneous data sources serves as an offline data synchronization framework, which is constructed by using the Framework+plugin architecture, abstracting reading and writing of a data source into Reader/Writer plugins which are integrated into the entire synchronization framework.

Considering that the data to be synchronized comes from different data sources, and data from different data sources may use different types of primary keys (such as string-type uuid, database-auto-increment numeric primary keys, or custom-rule primary keys). In practical applications, some source data read by the Reader plugin do not have a primary key. In this case, it is necessary to use a relational database to generate an auto-increment primary key, which may cause duplicate data insertion during incremental-data synchronization. In addition, since the Reader plugin and the Writer plugin may be located on different nodes, and the existing offline synchronization tool for heterogeneous data sources do not have a secure processing mechanism, it is impossible to detect data that has been tampered with during data synchronization transmission.

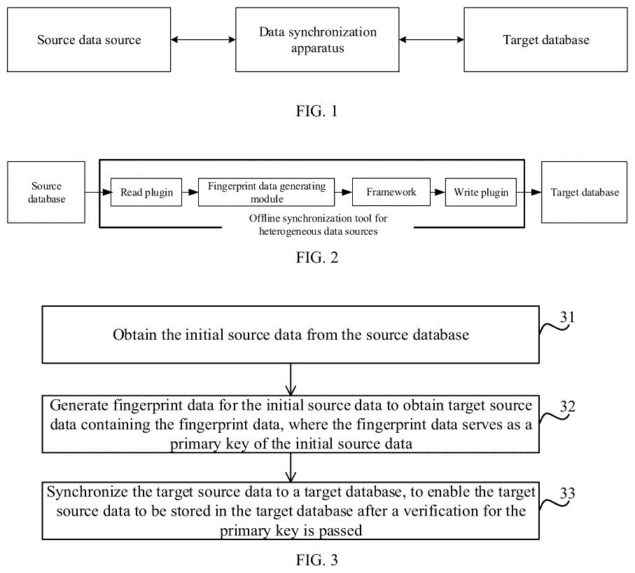

To address the above technical issues, embodiments of the present disclosure provide methods and systems for data synchronization, and computer-readable storage media. FIG. 1 is a block diagram of a system for data synchronization according to an embodiment. As shown in FIG. 1, the system for data synchronization includes a source database, a target database, and a data synchronization apparatus. The data synchronization apparatus is separately connected to the source database and the target database. The data synchronization apparatus is configured to obtain initial source data from the source database; generate fingerprint data of the initial source data to obtain target source data containing the fingerprint data, where the fingerprint data serves as a primary key for the initial source data; and synchronize the target source data to the target database such that the target source data is stored in the target database after the primary key is verified successfully. In this embodiment, generating fingerprint data with a unique feature for the initial source data can solve the problem of repeated synchronization during the data synchronization process, which improves the accuracy and efficiency of data synchronization.

It should be noted that considering that the source data can be from one source database or multiple source databases, the number of source databases can be set according to specific scenarios and is not limited here. Similarly, the target source data can also be synchronized to different target databases. Therefore, the number of target databases can be one or multiple, which can be set according to specific scenarios and is not limited here. For the convenience of description, in the present disclosure, one source database and one target database are used as examples to describe the solution of each embodiment.

In this embodiment, the above data synchronization apparatus can be implemented by using an offline synchronization tool for heterogeneous data sources. For example, the data synchronization apparatus can be constructed by using a Framework+plugin architecture. FIG. 2 is a block diagram of a system for data synchronization according to an embodiment. As shown in FIG. 2, the data synchronization apparatus in the system for data synchronization can include a Framework module, a fingerprint data generating module, a read plugin, and a write plugin. The Framework module is separately connected to the read plugin and the write plugin. The read plugin is configured to read initial source data to be synchronized from the source database. The fingerprint data generating module is configured to generate the fingerprint data for the initial source data and use the fingerprint data as the primary key of the initial source data. The Framework module is configured to forward the initial source data and the primary key as target source data to the write plugin. The write plugin is configured to write the target source data to the target database. In this way, the data synchronization apparatus can achieve the effect of synchronizing the data from the source database to the target database without repetition.

In this embodiment, the fingerprint data can be a message digest, and the fingerprint data generating module can include a preset fingerprint generating model. The fingerprint generating model can include but is not limited to the Message Digest (MD) algorithm, Secure Hash Algorithm (SHA), and Message Authentication Code (MAC) algorithm. The skilled in the art can choose appropriate algorithms based on specific scenarios. In the case where fingerprint data can be generated, the corresponding solution falls within the scope of protection of the present disclosure.

In an example, the fingerprint generating model is a Hash-based Message Authentication Code (HMAC) algorithm based on keys. The HMAC algorithm takes a message M and a key K as inputs and generates a message digest with a fixed length as an output. The message M is the initial source data, and the fixed-length message digest is the fingerprint data. In this way, fingerprint data is a message digest that can prevent tampering during data transmission and can be used as a unique identifier to compare with the primary keys in the target database, which avoids duplicate synchronization of data. In addition, in this example, generating fingerprint data for the initial source data can unify types of primary keys of existing data, which can avoid duplicate data insertion, and improve synchronization efficiency.

In this embodiment, only the function of the data synchronization apparatus transmitting target source data is described. In practical applications, the data synchronization apparatus serves as a data transmission channel for both read and write plugins, and can also handle functions such as buffering, data flow control, concurrency processing, and data conversion. Corresponding functions can be selected according to specific scenarios. In the case where normal target source data can be normally transmitted, the corresponding solution falls within the scope of protection of the present disclosure.

It should be noted that in the system for data synchronization shown in FIG. 2, the fingerprint data generating module is located between the read plugin and the Framework module. In some embodiment, the fingerprint data generating module can be integrated into the read plugin and/or the Framework module, which can be selected according to specific scenarios, and the corresponding solution falls within the scope of protection of the present disclosure.

In an embodiment, considering that the read plugin is usually set up in different source databases, the fingerprint data generating module can be integrated into the read plugin. Plugins for different data sources need to follow the framework's conventions for plugins, enabling each plugin to complete common steps of a data operation, i.e., the segmentation of concurrent tasks and the reading and transmitting of data. In this embodiment, the read plugin can call the startRead method of the read plugin after the task is started, and the startRead method uses the framework's recordSender interface as a parameter. This startRead method connects the data source according to the task configuration and reads the data to be synchronized. Then, the data to be synchronized is uniformly encapsulated into a framework-standard record object, i.e., Record object, and the record object is transmitted to the Framework framework for processing. During the process of encapsulating the read data into a Record object by the read plugin, the fingerprint data generating module can generate fingerprint data for the data to be synchronized. The generated fingerprint data is encapsulated as a primary key column in the Record object, i.e., the read plugin can directly obtain the target source data. That is, the read plugin can generate fingerprint data for the initial source data after reading the initial source data. In this case, the read plugin can directly obtain the target source data and upload the target source data to the Framework module. In this way, the Framework module does not need to generate fingerprint data, which can reduce the amount of data processed by the Framework module. Moreover, the fingerprint data is generated by read plugins, and the fingerprint data can be verified in the Framework module or the write plugin to determine whether the initial source data has been tampered with, which is beneficial for improving the security of the data synchronization process.

In another embodiment, the read plugin can call the startRead method of the read plugin after the task is started. The startRead method uses the framework's recordSender interface as a parameter. The startRead method connects to the data source according to the configuration and reads the data, and then encapsulates the data into the framework's unified record object, i.e., Record object. The fingerprint data generating module can be used as the recordSender interface method. The interface method is called during the processing of the Record object by the Framework module, to generate a unified fingerprint for the transmitted data. In this case, the fingerprint data generating module can generate fingerprint data for the initial source data transmitted by different read plugins. In this way, the fingerprint data generating module only needs to be deployed in the Framework module and does not need to be generated in various read plugins, which can reduce the workload of read plugins.

Moreover, generating fingerprint data for the initial source data in the Framework module can reduce the possibility of data transmission being tampered with during subsequent processes, which is beneficial for improving the security of the data synchronization process.

In an embodiment, after the write plugin task is started, a startWrite method of the write plugin is called. The startWrite method uses the framework's recordReceive interface as a parameter. The startWrite method receives the record object (i.e., Record object) from the Framework framework, connects the data source according to the task configuration, and writes the target source data. In this case, the fingerprint data generating module can obtain the initial source data in the target source data, such as the column data in the Record object, and generate verification fingerprint data. It is understandable that the generation method of the verification fingerprint data in the write plugin is the same as the generation method of the fingerprint data in the read plugin. Then, the write plugin can compare the verification fingerprint data and the primary key column in the Record object, and determine to transmit the target source data to the target database when the primary key column and verification fingerprint data are the same; determine that the target source data has been tampered with, and there is no need to synchronize the target source data when the primary key and verification fingerprint data are different. In this embodiment, the fingerprint data generating module is integrated within the write plugin to perform security verification on the target source data, which improves the security of the data synchronization process.

It should be noted that, considering the function and deployment location of the fingerprint data generating module, when the fingerprint data generating module is integrated within the read plugin, the fingerprint data generating module can be integrated within the Framework module and/or the write plugin, and the latter integrated fingerprint data generating module can perform security verification on the target source data. Alternatively, the fingerprint data generating module is integrated within the Framework module and/or the read plugin, and the fingerprint data generating module is integrated within the write plugin. The fingerprint data generating module within the write plugin performs security verification on the target source data. When the fingerprint data generating module is deployed within the read plugin, it can give developers greater flexibility, such as specifying which data to use as an input for generating the fingerprint, that is, only the specified data column is used to generate the primary key, and only the specified data column is verified. In this way, the corresponding write plugin also needs to be consistent with the fingerprint generation implementation of the read plugin. When the fingerprint data generating module is deployed within the Framework module, developers cannot determine the data range for generating the fingerprint, and fingerprint generation becomes a fixed and unified process, and all read plugins use unified rules to generate fingerprints. That is, the fingerprint data generated by the fingerprint data generating module can serve as the primary key or as the verification fingerprint data, and the deployment location can be selected according to specific scenarios, and the corresponding solution falls within the protection scope of the present disclosure.

In a scenario, the initial source data includes four columns of data: name, height, weight, and age. During the reading and verification processes, the fingerprint data generating module can generate fingerprint data and write the fingerprint data to the target source data or perform initial source data verification. In another scenario, if a business needs to add a column of “gender” data. To match the overlap, the fingerprint data generating module can first generate fingerprint data for the first four columns of data, where the fingerprint data serves as first fingerprint data. Then, the fingerprint data generating module can generate fingerprint data for original source data and newly added source data, that is, generate fingerprint data for the first five columns of data, where the fingerprint data serves as second fingerprint data. Then, the write plugin can use the first fingerprint data for verification and matching during the writing process. When the same fingerprint data exists in the target database, the newly added data column is inserted into the row corresponding to the first fingerprint data, and the second fingerprint data is also inserted into the corresponding row, or the data corresponding to the first fingerprint data in the target database is replaced by the target source data.

In another scenario, before writing to the target database, the system for data synchronization can preprocess the target source data as follows. The system for data synchronization can obtain history task information and determine the column combinations in the target source data used in history task information. Then, the system for data synchronization can group the data columns of the target source data based on the above column combinations. For example, the four columns of name, height, weight, and age can be divided into {name, height}, {name, weight}, {name, age, height}, {name, age, weight}, {name, age, height, weight}, and other column combinations. Afterwards, the system for data synchronization can generate different fingerprint data based on various column combinations, and these fingerprint data will be synchronously stored as secondary keys of the target source data in the target database, which is convenient for users to use different data columns when creating new tasks and insert data into different data column combinations in the target database. In this way, in this scenario, a single preprocessing can provide fingerprint data for multiple subsequent data synchronizations, which can reduce the data processing workload in the subsequent synchronization processes and improve data synchronization efficiency. In addition, this scenario can be applied to de-redundancy, simplification, and security processing of data in large-scale data, providing data support for user to create tasks and reducing the difficulty of managing system for data synchronizations.

In this embodiment, after the write plugin writes the target source data to the target database, the primary key can be read from the target database and the primary key can be compared with primary keys stored in the target database. When the primary key in the target source data already exists in the target database, it indicates that the target source data has been stored in the target database. In this case, the target database can update or replace the target source data. When the primary key in the target source data does not exist within the target database, the target source data can be inserted in the target database. In this way, this embodiment can achieve the effect of synchronizing the initial source data from the source database to the target database.

In the solutions provided by the embodiments of the present disclosure, initial source data can be obtained from the source database. Then, fingerprint data is generated for the initial source data to obtain target source data containing the fingerprint data, where the fingerprint data serves as the primary key of the initial source data. Afterwards, the target source data is synchronized to the target database, to store the target source data in the target database after the verification for the primary key is passed. In this embodiment, generating fingerprint data with a unique feature for the initial source data can solve the problem of repeated synchronization during the data synchronization process, which improves the accuracy and efficiency of data synchronization.

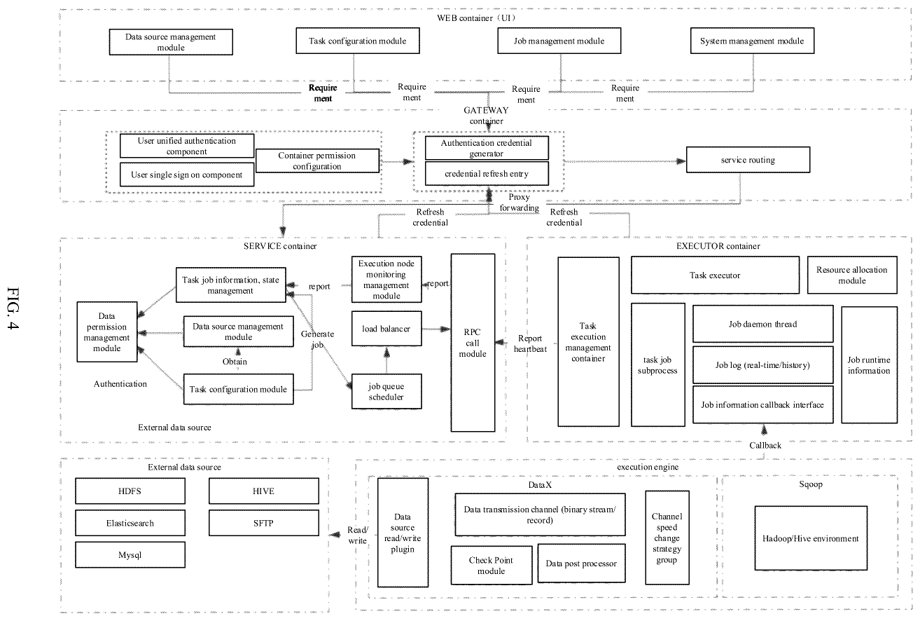

In combination with the systems for data synchronization shown in FIGS. 1 and 2, the embodiments of the present disclosure further provide a method for data synchronization. FIG. 3 is a flowchart of a method for data synchronization based on an embodiment. Referring to FIG. 3, the method for data synchronization includes steps 31 to 33.

In step 31, the initial source data is obtained from the source database.

In this embodiment, the data synchronization apparatus can obtain configuration information, and determine the source database, the source data to be synchronized in the source database, and the target database based on the configuration information. Then, the read plugin in the data synchronization apparatus can obtain the initial source data from the source database.

In step 32, fingerprint data is generated for the initial source data to obtain target source data containing the fingerprint data, where the fingerprint data serves as a primary key of the initial source data.

In this embodiment, the fingerprint data generating module in the data synchronization apparatus can generate fingerprint data for the initial source data. For example, a data synchronization apparatus can call a preset fingerprint generating model, and then input the initial source data to the fingerprint generating model to obtain fingerprint data. Afterwards, the data synchronization apparatus can use the initial source data and fingerprint data as the target source data to obtain the target source data containing fingerprint data. In this example, the fingerprint data is used as the primary key of the initial source data, which can be used for subsequent security verification and primary key comparison in the storage process.

It is understandable that the fingerprint data generating module in the data synchronization apparatus can be integrated into the read plugin and the Framework module to generate fingerprint data used as the primary key, and can also be integrated into the Framework module and the write plugin to generate verification fingerprint data for verification. The specific content can be found in the embodiments of the system for data synchronization, and will not be repeated here.

In step 33, the target source data is synchronized to a target database, to enable the target source data to be stored in the target database after a verification for the primary key is passed.

In this embodiment, a fingerprint data generating module can be deployed in the data synchronization apparatus, and the data synchronization apparatus can generate verification fingerprint data based on the initial source data in the target source data. Then, when the primary key in the target source data is the same as the verification fingerprint data, the data synchronization apparatus can transmit the target source data to the target database.

In this embodiment, the target database may obtain the primary key in the target source data and it is determined whether there is a primary key of stored data that is matched with the primary key in the target source data. When there is the primary key of the target source data in the target database, the target source data can be updated to the target database; when the primary key of the target source data does not exist in the target database, the target source data can be inserted into the target database. In this embodiment, updating and inserting operations can ensure that the data synchronized to the target database is not duplicated.

In this embodiment, synchronizing the target source data to the target database includes:
obtaining first fingerprint data of data columns other than a newly added data column and second fingerprint data of data columns containing the newly added data column; and
determining whether there is a primary key in the target database that is matched with the first fingerprint data;
in response to determining that the primary key of the target source data exists in the target database, updating the target source data and the second fingerprint data to the target database.

In this embodiment, the method further includes:
obtaining history task information;
determining column combinations in the target source data used in the history task information; and
generating fingerprint data based on column data of the column combinations, and synchronously storing the fingerprint data as a secondary key of the target source data in the target database.

It should be noted that the method shown in this embodiment matches the content of the system embodiment, and can refer to the content of the above system embodiment, which will not be repeated here.

The working principle of the system for data synchronization is described in conjunction with an embodiment, as shown in FIG. 4. The system for data synchronization includes: WEB container, GateWay container, Service container, Executor container, external data source, and execution engine.

The WEB container includes a data source management module, a task configuration module, a job management module, and a system management module. The data source management module is configured to configure and manage the connection information of data sources (such as IP addresses, ports, cluster configuration parameters, and authentication methods), manage all data sources created by users, provide common search, editing, and deletion methods, and perform connectivity testing and external permission settings on data sources. The task configuration module is configured to manage tasks configured by users. Users can create exchange tasks by combining existing data sources, and the created tasks will be mounted to the corresponding projects, and scheduled task execution and history data replay can be configured. The job management module is configured to list all execution jobs under related tasks by users, including job call time, completion time, execution parameters, execution nodes, and completion status. Specific execution details can be viewed through clicking on the detailed log. The system management module is configured to manage users and permissions of the system, and manage service execution nodes.

The WEB containers can provide a visual UI interface for interacting with users, facilitating users' configuration and management of various stages in the data synchronization process. For example, users can interact with the data source management module to enable the source management module to call the SERVICE API to add, delete, modify, or query source data sources and target data sources. These data sources can be understood as candidate source data sources and target data sources, that is, the data source for the read plugin and the write target for the write plugin. Users can interact with the task configuration module to enable the task configuration module to specify the source data source of the data to be synchronized and the target data source of the data to be written, and configure the field correspondence relationships between the data to be synchronized. These task configuration information can be stored to the database through the SERVICE API for subsequent use by reading and writing plugins. Users can interact with the job management module, and the job management module can add, delete, modify, query, and execute configured tasks. For example, clicking task execution will call the SERVICE API. The SERVICE will read task information to obtain task related configurations, and the SERVICE will call the Executor service to actually execute the task. The Exexutor service starts the read plugin and write plugin based on the task information to complete the synchronization of task data. Users can interact with the system management module, and the system management module can manage users, permissions, and more.

The GateWay communicates with the Service container and the Executor container, includes a user unified authentication component, a user single sign on component, a container permission configuration component, an authentication credential generator, a credential refresh entry, and a service routing module. The GateWay is configured for authentication and routing between various service containers, authentication of external requests, and interaction with external authentication servers, maintaining the routing link of the entire platform. The GateWay serves as the only entrance to the SERVICE service and the EXECUTOR service, uniformly receiving requests from the WEB container, completing login verification and distribution of requests.

The Service container includes a data permission management module, an execution node monitoring management module, a load balancer, a job queue scheduler, an RPC call module, a task configuration module, a data source management module, and a task job information status management module. The Service service provided by the Service container can manage multiple sets of API related to user usage, and is the entrance for users to create and configure data sources, perform data exchange tasks, and other business operations. The Service container receives requests from the front-end WEB container and processes the requests, which includes adding, deleting, modifying, querying the database, and scheduling tasks by calling the Executor container service.

The Executor container includes a task execution management container, a task executor, a resource allocation module, a task job subprocess, a job daemon thread, job log, job information callback interface, job runtime information, etc. The Executor service provided by this Executor container is the container that actually executes data exchange tasks, configured to interface with the execution engine, and also maintains multiple listening threads for task jobs, listening for job logs, whether timeout occurs, and job resource allocation. The Executor container receives requests from the WEB container and processes the requests, which includes querying task job status, querying task job logs, and so on. The Executor container further maintains a heartbeat connection with the Service container. When the WEB container starts a task, the Service service calls the Executor container service by passing task information. The Executor container service starts the data synchronization execution engine (i.e., Framework module) based on the task configuration information, and the execution engine starts the read and write plugins to run the data synchronization job.

The execution engine includes a Hadoop/Hive environment and an offline synchronization tool (i.e., the data synchronization apparatus in the above embodiment) for heterogeneous data sources. The offline synchronization tool for heterogeneous data sources includes data source read and write plugins (i.e., the read and write plugins in the above embodiments), a data transmission channel (i.e., the Framework module), a checkpoint module, a data post processor, a channel speed change strategy group, etc. The execution engine is configured to read the initial source data to be synchronized from an external data source and generate fingerprint data, to obtain the target source data, which is then written to an external data source (i.e., the target database) through a write plugin. The read and write plugins synchronize data based on the source and target databases and the corresponding relationship between the source and target data that are obtained from the task configuration information. These configuration information is configured by the user through the UI interface provided by the WEB container and saved in the database by calling the Service container service. When starting a task, the SERVICE container service reads the task configuration information and passes the task configuration information to the Executor container service. The Executor container service ultimately passes the configuration information to the execution engine for the read and write plugins to synchronize data based on the configuration information.

The working principle of the data synchronization coefficient shown in FIG. 4 is as follows.

(1) When using a system for data synchronization, users can open the interaction interface and enter the data management center in the interaction interface, where the data management center includes the data management module. The user can trigger the data management module to configure the source data source (i.e., source database) and target data source (i.e., target database). For example, when the user clicks “Add data source”, after the user fills in the data source information and clicks “Save”, a request to add a new data source is generated. This request calls the API in the Service service to store the data source information in the database, and the API returns a response message indicating a successful addition of the data source, and an instant message is presented on the UI interface indicating successful saving.

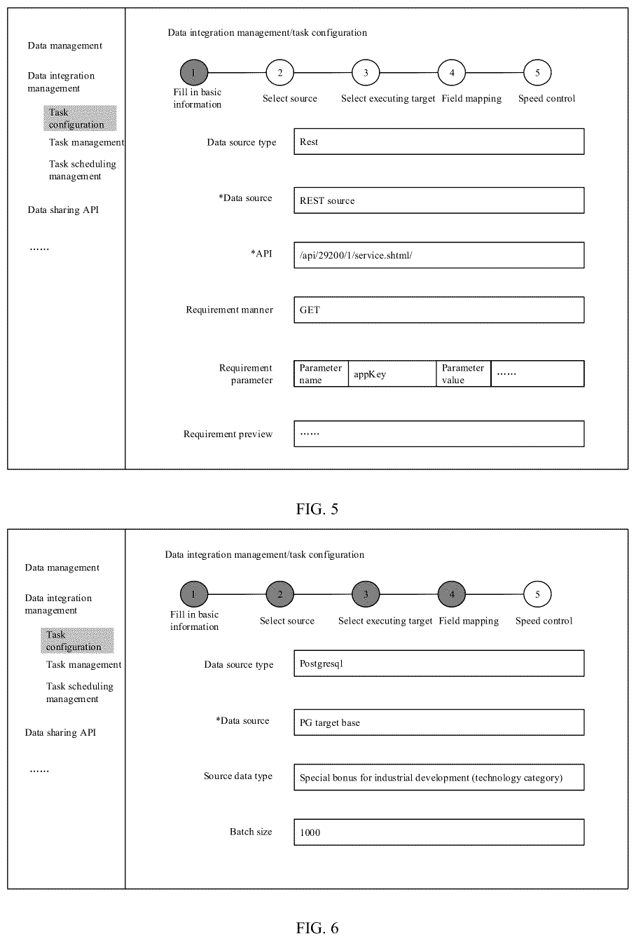

(2) Users can trigger the task configuration module to enter the data integration management task configuration page. Uses can create a new data synchronization task, fill in the task name, the project to which the task belongs, and other basic information, and click “Next” to configure the source data source. Any data source can be selected as the source data source, such as a rest data source, the user can configure the rest API address, request method, and request parameters, and test the availability of the data source connection. The effect is shown in FIG. 5.

(3) Users can click “Next” to configure the target data source and select postgresql data source. The effect is shown in FIG. 6.

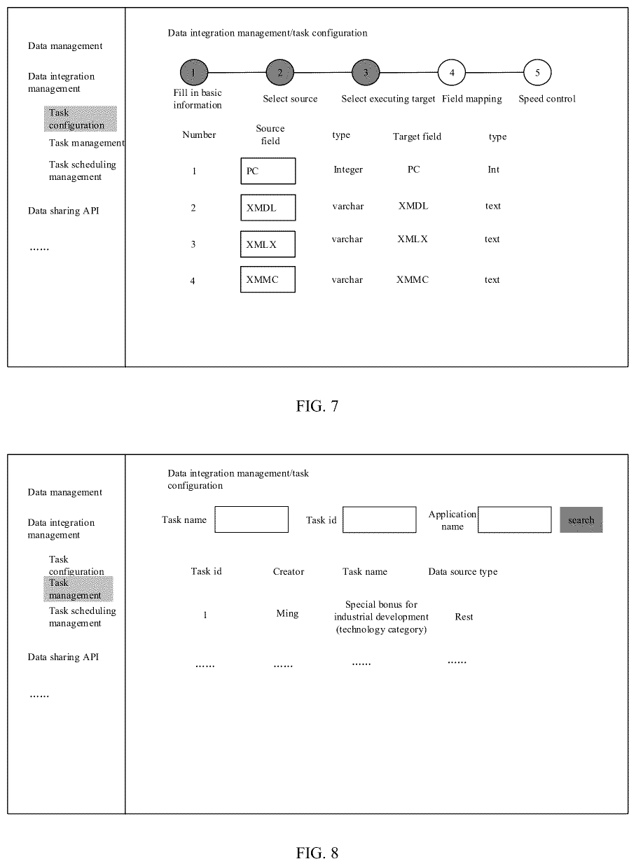

(4) Users can click “Next” to configure the correspondence relationships between source fields and target fields, and respectively correspond the fields of the source data source and the fields of the target data sources and the types, i.e., specify which column in the source data source corresponds to which column in the target data source. The field correspondence relationships can only be one-to-one, not one-to-many or many-to-one, and there are no unmatched field columns. The effect is shown in FIG. 7.

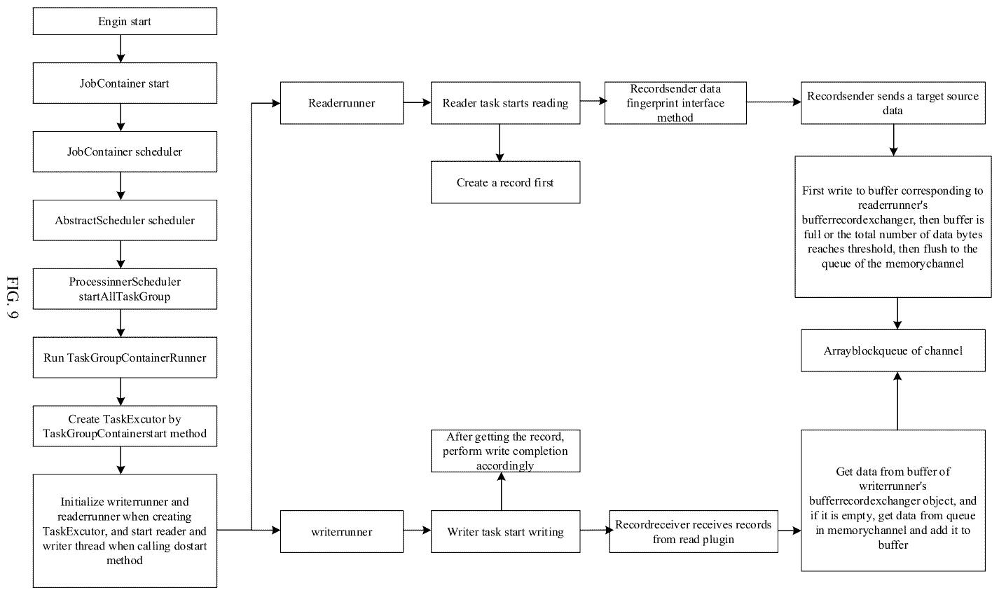

(5) Users can click “Next” to configure the data synchronization speed and click “Save”. The API of the Service service is called to save the configured data synchronization task information to the database, as shown in FIG. 8.

(6) Users can trigger the task management module to enter the task management interface. At this point, users can find the task that has just been configured and click “Execute”. At this point, the API of the Service service can be called to execute the task.

(7) The Service service calls the API of the Executor service to transmit task information to the Executor service for execution.

(8) The Executor service starts the offline synchronization tool (i.e., the data synchronization apparatus in FIG. 4) for heterogeneous data sources to execute the data synchronization process, as shown in FIG. 9, including:

(a) Parsing configuration files, including a task configuration file “job.json”, an engine configuration file “core.json”, and a reading and write plugin configuration file “plugin. json”.

(b) Merging the parsed configuration information into the task configuration information required for the task.

(c) Starting the engine by the engine startup method “Engine. start( )” based on task configuration information.

(d) Creating a task container “JobContainer” by the engine and starting the task container by the task container start method “JobContainer. start( )”. The task container start method “JobContainer. start( )” sequentially executes task preprocessing method “preHandler( )”, task initialization method “init( )”, read-write plugin prepare method “prepare( )”, task splitting method “split( )”, task scheduling method “schedule( )”, task post method “post( )”, and task post processing method “postHandle( )” and so on.

(e) The task initialization method init( ) initializes the read plugin “reader” and write plugin “writer” based on the task configuration information.

(f) The task prepare method “prepare( )” implements class loading of the read/write plugins by calling the read-write plugin prepare method “prepare( )”.

(g) The task splitting method “split( )” adjusts the number of channels through the channel number adjustment method “adjustChannelNumber( )”, and performs the fine-grained splitting for the read plugin “reader” and the write plugin “writer”.

(h) The counting of channels is mainly achieved based on the speed limit of bytes and records (i.e., initial source data or source data to be synchronized). If the user has not set the number of channels, the first step of the task splitting method “split( )” needs to calculate the size of the channel.

(i) The read and write subtask configuration merge method “mergeReaderAndWriterTaskConfigs( )” in the task splitting method “split( )” is responsible for merging the relationships between the read plugin “reader”, write plugin “writer”, and transmitter “transformer” to generate the configuration of the subtask “task”.

(j) The task scheduling method “schedule( )” allocates and generates subtask group “taskGroup” objects based on the configuration of the generated subtask “task” generated by splitting through the task splitting method “split( )”, and configures them based on the number of subtasks “task” and the number of subtasks “task” supported by a single subtask group “taskGroup”, where dividing the two can determine the number of subtask groups “taskGroup”.

(k) The task scheduling method “schdule( )” is executed internally through the task scheduling method “schedule( )” of the scheduler “AbstractScheduler”, and continues to execute start all subtask group methods “startAllTaskGroup( )” to create subtasks “task” related to all subtask group containers “TaskGroupContainer”. The subtask group container runner “TaskGroupContainerRunner” is responsible for running the subtask group container “TaskGroupContainer” to execute the assigned subtasks “task”.

(1) The subtask group container execution service “taskGroupContainerExecutorService” starts a fixed thread pool to execute the subtask group container runner “TaskGroupContainerRunner” object. The execution method “run( )” of “TaskGroupContainerRunner” calls the subtask group container start method “taskGroupContainer. start( )” method, to create a subtask executor “TaskExecutor” for each channel, and start the task through “taskExecutor. doStart( )”.

(m) The “recordSender” data fingerprint interface method uses HMAC algorithm to generate message digests (i.e. fingerprint data) of records, and thereby generate fingerprint data for the source data to be synchronized to obtain the target source data.

(n) The write plugin synchronizes the target source data to the target database, and performs security verification on the target source data before synchronization.

In this way, in the present disclosure, an interface method for generating data fingerprints is added for the offline synchronization tool of heterogeneous data sources. Before the read plugin reads the data record and transmits the data record to the writing plugin after processing, the interface method for generating data fingerprints is called to generate a digest string for the data record (i.e., the message digest or fingerprint data in the above embodiment). The digest string is used as the identification and verification value of the data record, such that the data synchronized to the target database has a unified data identifier, thereby avoiding the problem of inconsistent data identifiers of different data sources. Moreover, it achieves the effect of data tamper prevention and avoids the problem of duplicate data insertion.

In embodiments, a computer-readable storage medium is further provided, such as a memory including executable computer programs that can be executed by a processor to implement the method of the embodiment shown in FIG. 3. The readable storage medium may be a Read-Only Memory (ROM), a Random Access Memory (RAM), a CD-ROM, a magnetic tape, a floppy disk and an optical data storage device, etc.

After considering and practicing the disclosure of the specification, other embodiments of the present disclosure will be readily apparent to those skilled in the art. The present disclosure is intended to cover any modification, use or adaptation of the present disclosure. These modifications, uses or adaptations follow the general principles of the present disclosure and include common knowledge and conventional technical means in the technical field that are not disclosed in the present disclosure. The specification and embodiments herein are intended to be illustrative only and the real scope and spirit of the present disclosure are indicated by the following claims of the present disclosure.

It is to be understood that the present disclosure is not limited to the precise structures described above and shown in the accompanying drawings and may be modified or changed without departing from the scope of the present disclosure. The scope of protection of the present disclosure is limited only by the appended claims.

1. A method for data synchronization, applied to a system for data synchronization, wherein the method comprises:
obtaining initial source data from a source database;
generating fingerprint data for the initial source data to obtain target source data containing the fingerprint data, wherein the fingerprint data serves as a primary key of the initial source data; and
synchronizing the target source data to a target database, to enable the target source data to be stored in the target database after a verification for the primary key is passed.

2. The method according to claim 1, wherein generating the fingerprint data for the initial source data comprises:
calling a preset fingerprint generating model; and
inputting the initial source data to the fingerprint generating model, to obtain the fingerprint data.

3. The method according to claim 2, wherein the preset fingerprint generating model can be implemented by using at least one of a message digest algorithm, a secure hash algorithm, a message authentication code algorithm, or a key-based message authentication code algorithm.

4. The method according to claim 1, wherein synchronizing the target source data to the target database comprises:
generating verification fingerprint data based on the initial source data in the target source data; and
in response to determining that the primary key in the target source data is the same as the verification fingerprint data, transmitting the target source data to the target database.

5. The method according to claim 4, further comprising:
obtaining, by the target database, the primary key in the target source data; and
determining whether there is a primary key of stored data that is matched with the primary key in the target source data;
in response to determining that the primary key of the target source data exists in the target database, updating the target source data to the target database;
in response to determining that the primary key of the target source data does not exist in the target database, inserting the target source data into the target database.

6. The method according to claim 1, wherein synchronizing the target source data to the target database comprises:
obtaining first fingerprint data of data columns other than a newly added data column and second fingerprint data of data columns containing the newly added data column;
determining whether there is a primary key in the target database that is matched with the first fingerprint data; and
in response to determining that the primary key of the target source data exists in the target database, updating the target source data and the second fingerprint data to the target database.

7. The method according to claim 1, further comprising:
obtaining history task information;
determining column combinations in the target source data used in the history task information; and
generating fingerprint data based on column data of the column combinations, and synchronously storing the fingerprint data as a secondary key of the target source data in the target database.

8. A system for data synchronization, comprising a source database, a target database, and a data synchronization apparatus; wherein the data synchronization apparatus is configured to:
obtain initial source data from the source database and generate fingerprint data for the initial source data, to obtain target source data containing the fingerprint data, wherein the fingerprint data serves as a primary key of the initial source data; and
synchronize the target source data to the target database to store the target source data after a verification for the primary key is passed.

9. The system according to claim 8, wherein the data synchronization apparatus comprises a Framework module, a fingerprint data generating module, a read plugin, and a write plugin, wherein the Framework module is separately connected to the read plugin and the write plugin, wherein
the read plugin is configured to read the initial source data to be synchronized from the source database;
the fingerprint data generating module is configured to generate fingerprint data for the initial source data and use the fingerprint data as the primary key of the initial source data;
the Framework module is configured to forward the initial source data and the primary key together as the target source data to the write plugin; and
the write plugin is configured to write the target source data to the target database.

10. The system according to claim 9, wherein the fingerprint data generating module is integrated into the read plugin and/or the Framework module.

11. The system according to claim 9, wherein the fingerprint data generating module is integrated into the write plugin for generating verification fingerprint data based on the initial source data in the target source data, and the write plugin is further configured to:
compare the primary key in the target source data with the verification fingerprint data; and
transmit the target source data to the target database in response to determining that the primary key is the same as the verification fingerprint data.

12. The system according to claim 8, wherein the write plugin in the data synchronization apparatus is further configured to:
obtain first fingerprint data of data columns other than a newly added data column and second fingerprint data of data columns containing the newly added data column;
determine whether there is a primary key in the target database that is matched with the first fingerprint data; and
in response to determining that the primary key of the target source data exists in the target database, update the target source data and the second fingerprint data to the target database.

13. The system according to claim 8, wherein the data synchronization apparatus is further configured to:
obtain history task information;
determine column combinations in the target source data used in the history task information;
generate fingerprint data based on column data of the column combinations; and
synchronously store the fingerprint data as a secondary key of the target source data in the target database.

14. A non-transitory computer-readable storage medium, wherein when an executable computer program in the storage medium is executed by a processor, a method for data synchronization is implemented, wherein, the method is applied to a system for data synchronization, and comprises:
obtaining initial source data from a source database;
generating fingerprint data for the initial source data to obtain target source data containing the fingerprint data, wherein the fingerprint data serves as a primary key of the initial source data; and
synchronizing the target source data to a target database, to enable the target source data to be stored in the target database after a verification for the primary key is passed.
